(19) United States
(12) Patent Application Publication
(10) Pub. No.: US 2025/0007062 A1
(43) Pub. Date: Jan. 2, 2025

(54) METHOD FOR MANAGING THE PRESSURE APPLIED TO LITHIUM ION BATTERIES

(71) Applicant: AMPERE S.A.S., Boulogne Billancourt (FR)

(72) Inventors: Nathalie DELPUECH, Guyancourt Cedex (FR); David LERAY, Guyancourt Cedex (FR)

(73) Assignee: AMPERE S.A.S., Boulogne Billancourt (FR)

(21) Appl. No.: 18/717,005

(22) PCT Filed: Dec. 12, 2022
(86) PCT No.: PCT/EP2022/085296

§ 371 Date: Jun. 20, 2024

(30) Foreign Application Priority Data
Dec. 17, 2021 (FR) FR2113874

(51) Int. Cl. H01M 50/242; H01M 10/0525; H01M 10/44

(52) U.S. Cl. CPC H01M 50/242; H01M 10/0525; H01M 10/441

(57) ABSTRACT

A system applies a variable pressure to an electric battery including at least one electrochemical cell inserted between a first end plate and a second end plate which are parallel to one another. The system includes a first assembly including a first actuating wall, at least a first spring inserted between the first actuating wall and the first end plate, a link extending parallel to the first actuating wall and moved by an actuator. The link is connected to the first actuating wall by at least one cam, a first end of which is rotatably mounted on the link, and a second end of which is rotatably mounted about an axis of rotation rigidly connected to a stationary wall. The second end bears against the first actuating wall.

The present invention relates to a method for managing the pressure applied to lithium ion batteries.

When a Li-ion battery is charged, the lithium will form, with the silicon, silicon alloys of formula LiₓSi. The formation of these alloys leads to an increase in the volume of the Si particles which can reach up to 300% of the initial volume of the silicon particles. When the Li-ion battery is discharged, the LiₓSi alloys are delithiated, thus leading to a reduction in the size of the silicon particles. At the scale of the silicon electrode and the cell, quasi-reversible significant variations in volume, similar to respiration, will therefore occur over the cycles of charging and discharging of the battery. These variations in volume during the life of the battery (successive charges and discharges) will result in high mechanical stresses within the Li-ion battery. The Si particles may split, separate from the current collector and/or be electronically isolated from the percolation network of the electrode. These phenomena will then lead to a drop in battery performance. In addition, parasitic reactions will occur, generating an irreversible increase in volume, and therefore premature aging of the battery.

Application DE102009035482 A1 describes a lithium-ion electric battery for a motor vehicle comprising a plurality of battery cells clamped between two end plates and forming a stack of cells. More particularly, the lithium-ion battery comprises several battery cells, inserted between two plates, thus forming a stack of cells. A unit makes it possible to apply a pressure load to the stack of cells, in a stacking direction by means of a spring and using an active actuator. The actuator is controlled according to the service life/pressure characteristic diagram, or according to the measured values of temperature and/or pressure in the stack of cells, said values depending on the charging/discharging cycles.

A method according to the invention makes it possible to follow variations in the volume of Si particles over the various cycles of charging and discharging of an electric battery, by applying optimized pressure at all times. As a result, the performance of the Li-ion battery is preserved over time, and aging of said battery is significantly slowed down.

The subject of the invention is a system for applying a variable pressure to an electric battery comprising at least one electrochemical cell, inserted between a first end plate and a second end plate which are parallel to one another.

According to the invention, the system comprises a first assembly comprising a first actuation wall extending parallel to the two end plates and located opposite the first end plate, said first assembly comprising at least one first spring inserted between the first actuation wall and the first end plate, said first actuation wall being able to move toward or away from the first end plate to exert pressure on said first plate, under the effect of the movement of a link extending parallel to the first actuation wall and moved by an actuator, said link being connected to said first actuation wall by at least one cam, a first end of which is rotatably mounted on the link, and a second end of which is rotatably mounted about a rotation pin secured to a fixed wall parallel to the first actuation wall, said second end bearing against the first actuation wall. The principle of a method according to the invention is to be able to exert a homogeneous pressure on one of the two end plates of the electric battery via at least one spring, which can be compressed to a greater or lesser extent as a function of the movement of the link. To be specific, the movement of the link in one direction will cause a movement of said at least one cam in a first direction, which will bring the first actuation wall closer to the first end plate, causing compression of said at least one spring which will then exert increased pressure on said first end plate. A movement of the link in an opposite direction will cause a movement of said at least one cam in a second direction, which will move the first actuation wall away from the first end plate, causing relaxation of said at least one spring which will then exert reduced pressure on this first end plate. Preferably, the link is a straight elongate rod, and the actuator is configured to allow this rod to be moved in translation along a longitudinal axis of said rod, in both directions. In a system according to the invention, the first actuation wall is inserted between the link and the first end plate, and said at least one cam is inserted between the link and the first actuation wall. Preferably, the first system comprises a plurality of springs the number of which is greater than five, and a plurality of cams the number of which is greater than five. According to a particular embodiment, there are as many cams as there are springs.

According to a possible feature of the invention, the link is an elongate rod, the actuator moving said link in translation along a longitudinal axis of this link. The movement of the link under the effect of the actuator takes place along an axis which is parallel to the first actuation wall and to the first end plate, and the movement of the first actuation wall relative to the first end plate takes place along an axis which is perpendicular to the axis along which the link moves.

According to a possible feature of the invention, each cam comprises a rod connecting the first end to the second end, said second end comprising an elongate segment, which is positioned around the rotation pin. The second end taking the form of the elongate segment is fixed relative to the rod of the cam. The rotation pin is positioned at one end of the elongate segment, such that the rod of the cam is located on one side of this rotation pin and the elongate segment is located on the other side of said rotation pin. A movement of the link will cause a rotation of the rod of the cam, which will then cause a rotation of the elongate segment owing to the presence of the rotation pin. Since this elongate segment is in contact with the first actuation wall, the rotation of the elongate segment of the cam will cause the actuation wall to move in one direction or the other depending on the direction of rotation of the elongate segment.

According to a possible feature of the invention, the system comprises a computer intended to control the actuator to move the link in the direction and with the amplitude desired, so as to place the first actuation wall at a given distance from the first end plate, with the aim of compressing each first spring to a greater or lesser extent so as to exert the desired pressure on said first end plate. This computer is programmed so as to essentially take into account a phase of charging or discharging of the electric battery. Depending on the phase in question, the computer will trigger the actuator at a precise moment, which will cause a movement of the first actuation wall via the link and the cam, to increase or decrease the pressure exerted by said at least one first spring on the first end plate.

According to a possible feature of the invention, the system comprises a second assembly comprising a second actuation wall extending parallel to the two end plates and located opposite the second end plate, said second assembly comprising at least one second spring inserted between the second actuation wall and the second end plate, the direction of the forces exerted by said at least one second spring being parallel to the direction of the forces exerted by said at least one first spring, said second actuation wall bearing against a fixed wall which is parallel to said second actuation wall. This second assembly makes it possible to homogenize the general pressure exerted on the electric battery by the springs, by virtue of the presence of the two assemblies capable of each exerting pressure on each side of the electric battery.

According to a possible feature of the invention, the system comprises twelve first springs inserted between the first actuation wall and the first end plate and twelve second springs inserted between the second actuation wall and the second end plate.

According to a possible feature of the invention, the first springs are aligned along an axis which is parallel to the end plates and the second springs are also aligned along an axis which is parallel to said end plates. In this way, the first actuation wall and the second actuation wall will exert homogeneous pressure on the first end plate and on the second end plate, respectively.

According to a possible feature of the invention, each first spring and each second spring are formed of Belleville washers. Alternatively, other types of spring may be used, such as spiral springs or compression foam for example.

According to a possible feature of the invention, the system comprises a fixed frame enclosing the electric battery, the first actuation wall, the second actuation wall, said at least one first spring, said at least one second spring, the second actuation wall being in contact with a second flat wall of the frame and said at least one rotation pin, about which is mounted the second end of said at least one cam, being secured to a first flat wall of the frame which is parallel to said second flat wall, the link being located behind said first flat wall of the frame while being positioned outside of said frame.

Another subject of the invention is a method for using a system according to the invention over a cycle comprising a charging phase then a discharging phase of a Li-ion electric battery.

According to the invention, the method comprises the following steps:
a start step for which the cells are at the dimension x1 and the system exerts a force F1,
a step of charging of the electric battery for which the force exerted by the system increases to a value F2 which is greater than F1, because the cells of the battery have expanded during the charging phase and are now at a dimension x2 which is greater than x1,
a step of start of discharging of the battery comprising a step of prior activation of the system controlled by the computer for which the link is moved in translation in a direction causing a rotation of the cams in a first direction which will bring the first actuation wall closer to the first end plate, said system then instantly exerting a force F3 on the battery, which is greater than the force F2,
a step of end of discharging of the battery for which the system applies a force F4 on the battery which is lower than the force F3, this force F4 applied at the end of discharging being due to the cells having lost volume during this discharging phase,
a step of activation of the system controlled by the computer for which the link is moved in translation in an opposite direction causing a rotation of the cams in a second direction which will move the first actuation wall away from the first end plate, said system then instantly exerting a force F1 on the battery, which is lower than the force F4, to return the cells to their state of preloading before charging.

It is of course understood that the step of charging of the electric battery may be triggered for any initial state of charge of the battery, which is not necessarily zero. Likewise, the step of discharging of the battery may cease regardless of the state of discharge of the battery, which is not necessarily zero.

A detailed description of a preferred embodiment of a system for applying a variable pressure according to the invention is set out below with reference to the following figures:

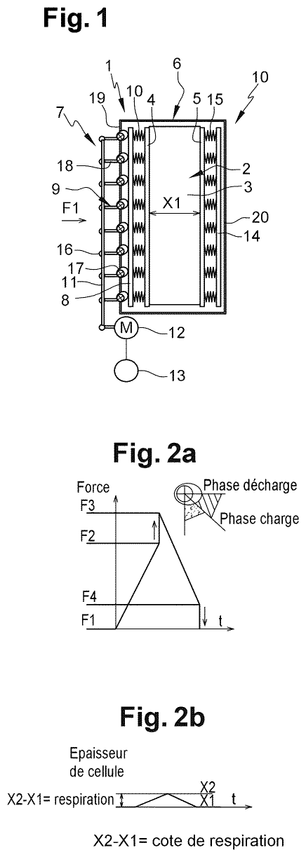

FIG. 1 is a schematic view of a system for applying a variable pressure to an electric battery according to the invention, the cells being at the dimension x1 and the system exerting a force F1,

FIG. 2a shows a diagram illustrating an example of the force applied to the cells of an electric battery over time, during a phase of charging then discharging of said battery,

FIG. 2b shows a diagram illustrating an example of a variation in the width of a cell of a battery over time, during a phase of charging then discharging of said battery,

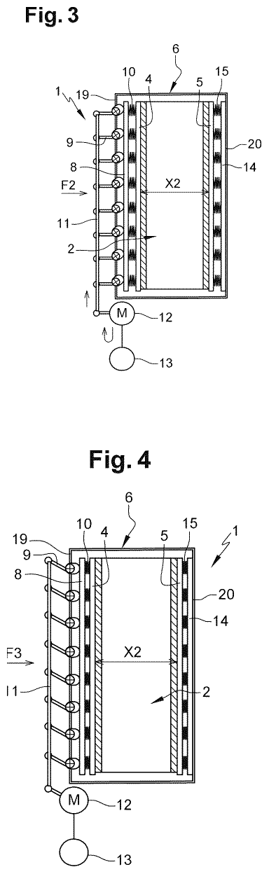

FIG. 3 is a schematic view of a system according to the invention when the electric battery is at the end of charging, the cells being at the dimension x2>x1 and the force exerted is the force F2>F1 due to the increase in size of the cells,

FIG. 4 is a schematic view of a system according to the invention for which a force F3>F2 is exerted on the cells, which are at the dimension x2, when they are beginning to discharge,

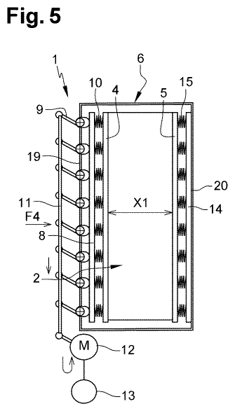

FIG. 5 is a schematic view of a system according to the invention when the electric battery is at the end of discharging, the cells having returned to the dimension x1 and said system exerting a force F4,

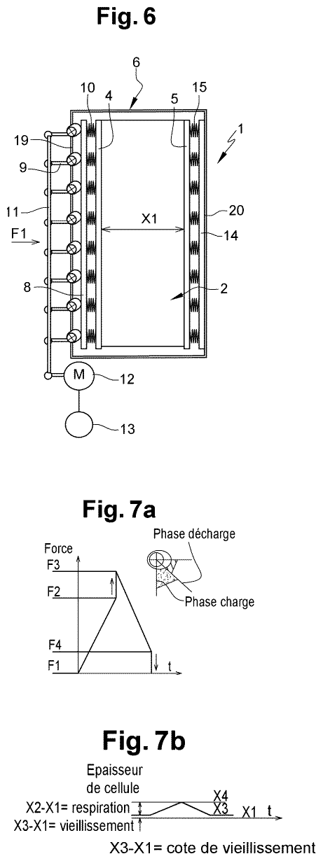

FIG. 6 is a schematic view of a system according to the invention for which the actuator reduces the pressure on the cells when they are at the start of charging, said cells being at the dimension x1 and the system applying a force F1,

FIG. 7a shows a diagram illustrating an example of the force applied to the cells of an electric battery over time, during a phase of charging then discharging of said battery, said cells having expanded due to aging, to the dimension x3 instead of x1,

FIG. 7b shows a diagram illustrating an example of a variation in the dimension of the cells of a battery over time, during a phase of charging then discharging of said battery, said cells having expanded due to aging, to the dimension x3 instead of x1,

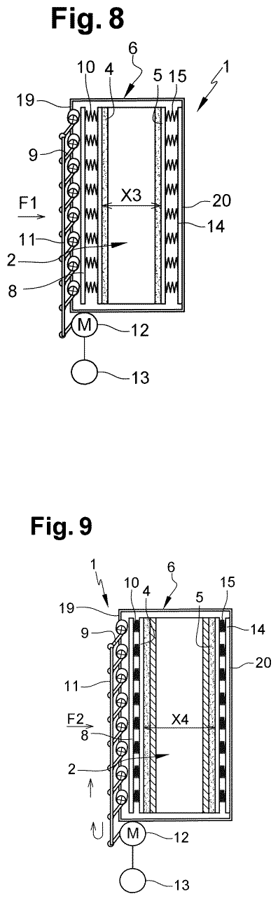

FIG. 8 is a schematic view of a system according to the invention when the electric battery is at the start of charging, the cells being at the dimension x3, and a force of F1 is exerted,

FIG. 9 is a schematic view of a system according to the invention when the electric battery is at the end of charging, the cells being at the dimension x4 greater than x3, the force then exerted is the force F2 greater than F1 due to the increase in size of the cells,

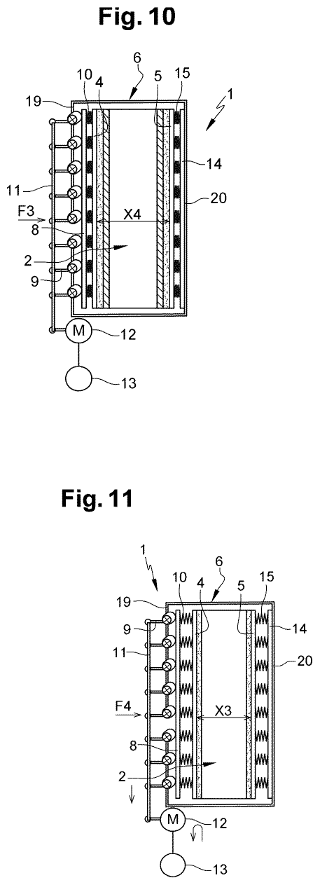

FIG. 10 is a schematic view of a system according to the invention for which a force F3 greater than F2 is exerted on the cells, which are at the dimension x4, when they are beginning to discharge,

FIG. 11 is a schematic view of a system according to the invention when the electric battery is at the end of discharging, the cells having returned to the dimension x3 and said system exerting a force F4,

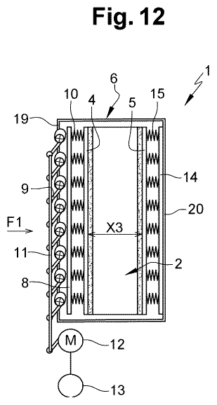

FIG. 12 is a schematic view of a system according to the invention for which the actuator reduces the pressure on the cells when they are at the start of charging, said cells being at the dimension x3 and the system applying a force F1.

An electric battery 2 is made up of a series of several Li-ion cells 3 which are perfectly aligned, being in contact with one another. This electric battery 2 comprises a first end plate 4 and a second end plate 5 enclosing the cells 3 of said electric battery 2. Schematically, these two end plates 4, 5 have substantially the same dimensions as the cells 3, said cells 3 being inserted between these two end plates 4, 5 while being parallel to said end plates 4, 5.

A system 1 for applying a variable pressure according to the invention is capable of applying pressure on the first end plate 4 and on the second end plate 5, and comprises:
a frame 6,
a first assembly 7 comprising a first actuation wall 8, several cams 9, several first springs 10, a link 11, an actuator 12 capable of moving said link 11 and a computer 13 intended to control said actuator 12 as a function of the phase in which the battery 2 is, namely charging or discharging, and from start of life to end of life of the battery,
a second assembly 40 comprising a second actuation wall 14 and several second springs 15.

The link 11 is represented by an elongate straight rod, and the actuator 12, depending on the instruction it receives from the computer 13, is capable of moving said link 11 in translation along a longitudinal axis of said link 11, in one direction or the other.

Each cam 9 comprises a first end 16 which is mounted articulated on the link 11, and a second end 17 comprising an elongate segment, said first end 16 and said second end 17 being connected by a connecting rod 18. The second end 17 is connected to the connecting rod 18 in a fixed manner, such that the elongate segment is inclined relative to said connecting rod 18. The elongate segment of the second end 17 of each cam 9 passes around a connecting pin which is secured to a first wall 19 of the frame 6, which is parallel to the first actuation wall 8 and to the first end plate 4 of the electric battery 2.

The first actuation wall 8 is flat and is arranged parallel to the first end plate 4 of the battery 2 and facing same. A series of several first springs 10 is inserted between the first end plate 4 of the electric battery 2 and the first actuation wall 8, said first springs 10 possibly being twelve in number, for example. These first springs 10 are aligned along the first actuation wall 8 and along the first end plate 4 of the battery 2. The link 11 extends parallel to the first actuation wall 8 and to the first end plate 4 of the electric battery 2, such that said first actuation wall 8 is positioned between said link 11 and said first end plate 4.

The second actuation wall 14 is flat and is arranged parallel to the second end plate 5 of the electric battery 2 and facing same. A series of several second springs 15 is inserted between the second end plate 5 of the battery 2 and the second actuation wall 14, said second springs 15 possibly being twelve in number, for example. These second springs 15 are aligned along the second actuation wall 14 and along the second end plate 5 of the electric battery 2. Under the effect of the second springs 15, the second actuation wall 14 is pressed against a second wall 20 of the frame 6 which is parallel to the first wall 19 of the frame 6 on which the rotation pins of the cams 9 are fixed. This second wall 20 of the frame 6 is parallel to the second actuation wall 14 and to the second end plate 5 of the battery 2. In other words, the second actuation wall 14 is inserted between the second wall 20 of the frame 6 and the second end plate 5 of the battery 2.

The first springs 10 and the second springs 15 may for example be formed of Belleville washers. The first springs 10 exert forces in a direction which is perpendicular to the planes of the first actuation wall 8 and the first end plate 4, and the second springs 15 exert forces in a direction which is perpendicular to the planes of the second actuation wall 14 and the second end plate 5.

The cams 9 are mounted in a system 1 according to the invention, such that their second ends 17 comprising the elongate segment bear against the first actuation wall 8.

The operating principle of such a system is that a computer 13 to which the actuator 12 is connected will send to this actuator 12 instructions in the form of signals, to move the link 11 in one direction or the other. The link 11 is then moved in translation along its longitudinal axis in a given direction and with the desired amplitude, thus causing the cams 9 to pivot. The rotation of the connecting rod 18 of each cam 9 causes a pivoting of the second end 17 of said cam which is fixed to said rod 18 by virtue of the presence of the rotation pin secured to the first wall 19 of the frame 6, the pivoting of this second end 17 bringing the first actuation wall 8 closer to or further away from the first end plate 4 of the electric battery 2. The first springs 10 will then either be compressed or relax, to apply pressure to a greater or lesser extent on said first end plate 4. The second assembly 40 will then react in the same way as the first component 7, in other words if the first springs 10 are compressed under the effect of the pivoting of the cams 9, the second springs 15 will also be compressed, and if they relax, said second springs 15 will also relax. The second assembly 40 plays a relay role to balance the pressure exerted on the battery 2 by the first assembly 7.

With reference to FIGS. 1 to 6, when the cells of the battery 2 are not aged, a method for using a system 1 according to the invention over a complete cycle comprising a phase of charging followed by a phase of discharging said battery 2, comprises the following steps:
With reference to FIGS. 1 and 2a, a start step for which the cells are at the dimension x1 and the system 1 exerts a force F1,
With reference to FIGS. 2a, 2b and 3, a step of charging of the battery 2 for which the force exerted by the system 1 increases to a value F2 which is greater than F1, because the cells of the battery 2 have expanded during the charging phase and are now at a dimension x2 which is greater than x1. This force F2 is the resulting force exerted by the system 1 at the end of charging,
With reference to FIGS. 2a and 4, a step of start of discharging of the electric battery 2 comprising a step of prior activation of the system 1 controlled by the computer 13 for which the link 11 is moved in translation upward, causing a rotation of the cams 9 in a direction which will bring the first actuation wall 8 closer to the first end plate 4. During this prior activation step, the system 1 then instantly exerts a resulting force F3 on the battery 2, which is greater than the force F2,
With reference to FIGS. 2a, 2b and 5, a step of end of discharging for which the cells have returned to the dimension x1 and the system applies a resulting force F4 on the battery 2, which is lower than the force F3, this force F4 applied at the end of discharging being due to the cells having lost volume during this discharging phase,
With reference to FIGS. 2a and 6, a step of activation of the system 1 controlled by the computer 13 for which the link 11 is moved in translation downward, causing a rotation of the cams 9 in a direction which will move the first actuation wall 8 away from the first end plate 4. The system 1 then instantly exerts a force F1 on the battery 2, which is lower than the force F4. It is then in the position ready for charging.

With reference to FIGS. 7 to 12, when the cells of the battery 2 have aged, their volume tends to increase over time, this phenomenon being irreversible. The use of a system 1 according to the invention over a complete cycle of a phase of charging followed by a phase of discharging of said aged battery follows the following steps:
With reference to FIGS. 7a, 7b and 8, a start step for which the cells are at the dimension x3 which is greater than the initial dimension x1 when the cells are not aged, and the system 1 exerts a resulting force F1,
With reference to FIGS. 7a, 7b and 9, a step of charging of the battery 2 for which the force exerted by the system 1 increases to a value F2 which is greater than F1, because the aged cells of the battery 2 have expanded during the charging phase and are now at a dimension x4 which is greater than x3. This force F2 is the force exerted by the system 1 at the end of charging,
With reference to FIGS. 7a and 10, a step of start of discharging of the electric battery 2 comprising a step of prior activation of the system 1 controlled by the computer 13 for which the link 11 is moved in translation upward, causing a rotation of the cams 9 in a direction which will bring the first actuation wall 8 closer to the first end plate 4. During this prior activation step, the system 1 then instantly exerts a force F3 on the battery 2, which is greater than the force F2,
With reference to FIGS. 7a, 7b and 11, a step of end of discharging for which the cells have returned to a dimension x3 at the end of discharging and the system applies a force F4 on the battery 2, which is lower than the force F3, this force F4 applied at the end of discharging being due to the cells having lost volume during this discharging phase,
With reference to FIGS. 7a and 12, a step of activation of the system 1 controlled by the computer 13 for which the link 11 is moved in translation downward, causing a rotation of the cams 9 in a direction which will move the first actuation wall 8 away from the first end plate 4. The system 1 then instantly exerts a force F1 on the battery 2, which is lower than the force F4.

The various steps of the method for managing the pressure when the battery cells have aged are identical to those of the method for managing the pressure when they have not aged, only their initial dimension x3 is greater than the initial dimension x1 of the cells which have not aged, owing to an initial increase in the volume of these aged cells.

Note that the battery 2 charging step is carried out not only when its state of charge is zero, but from any state of charge. Likewise, the discharging step is not systematically carried out until the state of charge of the battery has a value of zero. It may be interrupted at any time even though the state of charge of the battery is not zero.

1-10. (canceled)

11. A system for applying a variable pressure to an electric battery comprising at least one electrochemical cell, inserted between a first end plate and a second end plate which are parallel to one another, the system comprising:
a first assembly comprising a first actuation wall extending parallel to the two end plates and located opposite the first end plate, said first assembly comprising at least one first spring inserted between the first actuation wall and the first end plate, said first actuation wall being configured to move toward or away from the first end plate to exert pressure on said first plate, under the effect of the movement of a link extending parallel to the first actuation wall and moved by an actuator, said link being connected to said first actuation wall by at least one cam, a first end of which is rotatably mounted on the link, and a second end of which is rotatably mounted about a rotation pin secured to a fixed wall parallel to the first actuation wall, said second end bearing against the first actuation wall.

12. The system for applying a pressure as claimed in claim 11, wherein the link is an elongate rod, and the actuator moves said link in translation along a longitudinal axis of this link.

13. The system for applying a pressure as claimed in claim 12, wherein each cam comprises a rod connecting the first end to the second end, and said second end comprises an elongate segment, which is positioned around the rotation pin.

14. The system for applying a pressure as claimed in claim 11, further comprising a computer configured to control the actuator to move the link in the direction and with an amplitude so as to place the first actuation wall at a given distance from the first end plate to compress each first spring to a greater or lesser extent so as to exert the desired pressure on said first end plate.

15. The system for applying a pressure as claimed in claim 11, further comprising a second assembly comprising a second actuation wall extending parallel to the two end plates and located opposite the second end plate, said second assembly comprising at least one second spring inserted between the second actuation wall and the second end plate, the direction of the forces exerted by said at least one second spring being parallel to the direction of the forces exerted by said at least one first spring, said second actuation wall bearing against a fixed wall which is parallel to said second actuation wall.

16. The system for applying a pressure as claimed in claim 15, further comprising twelve first springs inserted between the first actuation wall and the first end plate and twelve second springs inserted between the second actuation wall and the second end plate.

17. The system for applying a pressure as claimed in claim 15, wherein the first springs are aligned along an axis which is parallel to the end plates and the second springs are also aligned along an axis which is parallel to said end plates.

18. The system for applying a pressure as claimed in claim 15, wherein each first spring and each second spring are formed of Belleville washers.

19. The system for applying a pressure as claimed in claim 15, further comprising a fixed frame enclosing the electric battery, the first actuation wall, the second actuation wall, said at least one first spring, said at least one second spring, wherein the second actuation wall is in contact with a second flat wall of the frame and said at least one rotation pin, about which is mounted the second end of said at least one cam, is secured to a first flat wall of the frame which is parallel to said second flat wall, the link being located behind said first flat wall of the frame while being positioned outside of said frame.

20. A method for using the system for applying a pressure as claimed in claim 11 over a cycle comprising a charging phase then a discharging phase of a Li-ion electric battery, the method comprising:
starting with the cells at a dimension x1 and the system exerting a force F1;
charging the electric battery for which the force exerted by the system increases to a value F2 which is greater than F1, because the cells of the battery have expanded during the charging phase and are now at a dimension x2 which is greater than x1;
starting a discharging of the battery comprising a prior activation of the system controlled by the computer for which the link is moved in translation in a direction causing a rotation of the cams in a first direction which will bring the first actuation wall closer to the first end plate, said system then instantly exerting a force F3 on the battery, which is greater than the force F2;
ending the discharging of the battery for which the system applies a force F4 on the battery which is lower than the force F3, the force F4 applied at the end of discharging being due to the cells having lost volume during the discharging phase; and
activating the system controlled by the computer for which the link is moved in translation in an opposite direction causing a rotation of the cams in a second direction which will move the first actuation wall away from the first end plate, said system then instantly exerting the force F1 on the battery, which is lower than the force F4, to return the cells to a state of preloading before charging.
